(19) United States
(12) Patent Application Publication
(10) Pub. No.: US 2025/0191213 A1
(43) Pub. Date: Jun. 12, 2025

(54) APPARATUS FOR CONTROLLING VEHICLE AND METHOD THEREOF

(71) Applicants: Hyundai Motor Company, Seoul (KR); Kia Corporation, Seoul (KR); UIF (University Industry Foundation), Yonsei University, Seoul (KR)

(72) Inventors: Seong Hwan Kim, Seoul (KR); Jongeun Choi, Seoul (KR); Taek Hyung Cho, Seoul (KR)

(21) Appl. No.: 18/748,512

(22) Filed: Jun. 20, 2024

(30) Foreign Application Priority Data
Dec. 8, 2023 (KR) 10-2023-0178077

(51) Int. Cl. G06T 7/70; G06V 10/764; G06V 20/56

(52) U.S. Cl. CPC G06T 7/70; G06V 10/764; G06V 20/56; G06T 2207/20084

(57) ABSTRACT

A vehicle control apparatus includes a first sensor, a second sensor, a processor, and a memory storing first and second neural network models. The processor is configured to obtain first object data for predicting information related to the external object based on entering the first sensor data into the first neural network model, obtain second object data for predicting information related to the external object based on entering the second sensor data into the first neural network model the first object data or the second object data as input data to be entered into the second neural network model, and output data including a final location of the external object or a final type of the external object based on entering the input data into the second neural network model.

### CROSS-REFERENCE TO RELATED APPLICATIONS

This application claims the benefit of priority to Korean Patent Application No. 10-2023-0178077, filed in the Korean Intellectual Property Office on Dec. 8, 2023, the entire contents of which are incorporated herein by reference.

### TECHNICAL FIELD

The present disclosure relates to an apparatus for controlling a vehicle and a method thereof.

### BACKGROUND

Various studies are being conducted to identify an external object by using various sensors to assist the driving of a vehicle.

In particular, while the vehicle is driving in a driving assistance device activation mode or an autonomous driving mode, the external object may be identified by using various sensors (e.g., a LiDAR, a camera, or RADAR).

The need exists, however, to improve the safety and reliability of systems and methods that sense external objects when controlling a vehicle.

### SUMMARY

The present disclosure relates to an apparatus for controlling a vehicle and a method thereof and, in particular embodiments, related to a technology for identifying an external object based on pieces of sensor data.

Embodiments can solve problems occurring in the prior art while advantages achieved by the prior art are maintained intact.

An aspect of the present disclosure provides a vehicle control apparatus that accurately detects an external object by using sensor data obtained by various sensors, and a method thereof.

An aspect of the present disclosure provides a vehicle control apparatus that accurately detects the external object by identifying the external object based on entering pieces of sensor data into a neural network model, and a method thereof.

An aspect of the present disclosure provides a vehicle control apparatus that accurately detects the external object under various conditions by detecting the external object by using various neural network models, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a first sensor that obtains first sensor data based on identifying an external object, a second sensor that obtains second sensor data based on identifying the external object, a (non-transitory) memory that stores a first neural network model and a second neural network model, and a processor. The processor may obtain first object data for predicting at least one of a first location of the external object, or a type of the external object, or any combination thereof based on entering the first sensor data into the first neural network model, may obtain second object data for predicting at least one of a second location of the external object, or the type of the external object, or any combination thereof based on entering the second sensor data into the first neural network model, may select at least one of the first object data, or the second object data, or any combination thereof as input data to be entered into the second neural network model, based on at least one of a distance between the first location and the second location, first reliability of the first object data, or second reliability of the second object data, or any combination thereof, and may output data including at least one of a final location of the external object, or a final type of the external object, or any combination thereof based on entering the input data into the second neural network model.

In an embodiment, the processor may select at least one of the first object data, or the second object data, or any combination thereof as the input data based on whether the first reliability and the second reliability exceed reference reliability.

In an embodiment, the processor may identify the second reliability based on the first reliability exceeding the reference reliability, may select the first object data and the second object data as the input data based on whether the second reliability exceeds the reference reliability, and may select the first object data as the input data based on the second reliability being smaller than or equal to the reference reliability.

In an embodiment, the processor may identify the second reliability based on the first reliability being smaller than or equal to the reference reliability, may select the second object data as the input data, based on whether the second reliability exceeds the reference reliability, may remove the first object data and the second object data based on the second reliability being smaller than or equal to the reference reliability, and may select third object data, which is based on sensor data obtained by a third sensor different from the first sensor and the second sensor, as the input data.

In an embodiment, the processor may identify the first location, which is generated by the first object data and which indicates a center point of a first bounding box corresponding to the external object, may identify the second location, which is generated by the second object data and which indicates a center point of a second bounding box corresponding to the external object, and may determine whether a distance between the first location and the second location exceeds a reference distance.

In an embodiment, the processor may remove the first object data and the second object data based on the distance between the first location and the second location exceeding the reference distance, and may select third object data, which is based on sensor data obtained by a third sensor different from the first sensor and the second sensor, as the input data.

In an embodiment, the processor may determine whether the first reliability and the second reliability exceed reference reliability, based on a fact that the distance between the first location and the second location is smaller than or equal to the reference distance.

In an embodiment, the processor may identify a first bounding box, which is generated by the first object data and which corresponds to the external object, may identify a second bounding box, which is generated by the second object data and which corresponds to the external object, may identify an area where the first bounding box overlaps the second bounding box, and may train the second neural network model based on the overlapped area, or select at least one of the first object data, or the second object data, or any combination thereof as the input data.

In an embodiment, the processor may identify data uncertainty for the input data based on the first sensor data and the second sensor data, which are entered into the first neural network model, may identify model uncertainty for the second neural network model based on a third neural network model different from the second neural network model, and may output the output data based on the input data, to which the data uncertainty is applied, and the second neural network model to which the model uncertainty is applied.

In an embodiment, the second neural network model includes a multi-layer perceptron neural network.

According to an aspect of the present disclosure, a vehicle control method may include obtaining first object data for predicting at least one of a first location of an external object, or a type of the external object, or any combination thereof based on entering first sensor data, which is obtained based on identifying the external object through a first sensor, into a first neural network model stored in a memory, obtaining second object data for predicting at least one of a second location of the external object, or the type of the external object, or any combination thereof based on entering second sensor data, which is obtained based on identifying the external object through a second sensor, into a second neural network model stored in the memory, selecting at least one of the first object data, or the second object data, or any combination thereof as input data to be entered into the second neural network model, based on at least one of a distance between the first location and the second location, first reliability of the first object data, or second reliability of the second object data, or any combination thereof, and outputting output data including at least one of a final location of the external object, or a final type of the external object, or any combination thereof based on entering the input data into the second neural network model.

According to an embodiment, the vehicle control method may further include selecting at least one of the first object data, or the second object data, or any combination thereof as the input data based on whether the first reliability and the second reliability exceed reference reliability.

According to an embodiment, the vehicle control method may further include identifying the second reliability based on the first reliability exceeding the reference reliability, selecting the first object data and the second object data as the input data based on whether the second reliability exceeds the reference reliability, and selecting the first object data as the input data based on the second reliability being smaller than or equal to the reference reliability.

According to an embodiment, the vehicle control method may further include identifying the second reliability based on the first reliability being smaller than or equal to the reference reliability, selecting the second object data as the input data, based on whether the second reliability exceeds the reference reliability, removing the first object data and the second object data based on the second reliability being smaller than or equal to the reference reliability, and selecting third object data, which is based on sensor data obtained by a third sensor different from the first sensor and the second sensor, as the input data.

According to an embodiment, the vehicle control method may further include identifying the first location, which is generated by the first object data and which indicates a center point of a first bounding box corresponding to the external object, identifying the second location, which is generated by the second object data and which indicates a center point of a second bounding box corresponding to the external object, and determining whether a distance between the first location and the second location exceeds a reference distance.

According to an embodiment, the vehicle control method may further include removing the first object data and the second object data based on the distance between the first location and the second location exceeding the reference distance, and selecting third object data, which is based on sensor data obtained by a third sensor different from the first sensor and the second sensor, as the input data.

According to an embodiment, the vehicle control method may further include determining whether the first reliability and the second reliability exceed reference reliability, based on a fact that the distance between the first location and the second location is smaller than or equal to the reference distance.

According to an embodiment, the vehicle control method may further include identifying a first bounding box, which is generated by the first object data and which corresponds to the external object, identifying a second bounding box, which is generated by the second object data and which corresponds to the external object, identifying an area where the first bounding box overlaps the second bounding box, and training the second neural network model based on the overlapped area, or selecting at least one of the first object data, or the second object data, or any combination thereof as the input data.

According to an embodiment, the vehicle control method may further include identifying data uncertainty for the input data based on the first sensor data and the second sensor data, which are entered into the first neural network model, identifying model uncertainty for the second neural network model based on a third neural network model different from the second neural network model, and outputting the output data based on the input data, to which the data uncertainty is applied, and the second neural network model to which the model uncertainty is applied.

In an embodiment, the second neural network model includes a multi-layer perceptron neural network.

In an embodiment, the external object may be identified by fusing pieces of sensor data obtained through the sensors if the external object is identified by using the various sensors.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an embodiment of the present disclosure;

FIG. 2 shows an example of a first neural network model and/or a second neural network model, according to an embodiment of the present disclosure;

FIG. 3 shows an example of first object data and second object data, in an embodiment of the present disclosure;

FIG. 4 shows an example of removing data with relatively low reliability, in an embodiment of the present disclosure;

FIG. 5 shows an example of obtaining output data, in an embodiment of the present disclosure;

FIG. 6 shows an example of outputting output data, in an embodiment of the present disclosure;

FIG. 7 shows an example of a flowchart associated with a vehicle control method, according to an embodiment of the present disclosure;

FIG. 8 shows an example of a process using a distance between center points of bounding boxes, or an area in which bounding boxes overlap each other, in an embodiment of the present disclosure;

FIG. 9 shows an example of creating a bounding box corresponding to an external object by using data of a first time point and data of a second time point before the first time point, in an embodiment of the present disclosure;

FIG. 10 shows an example of a flowchart associated with a vehicle control method, according to an embodiment of the present disclosure; and

FIG. 11 shows a computing system related to a vehicle control apparatus or vehicle control method, according to an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted if they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

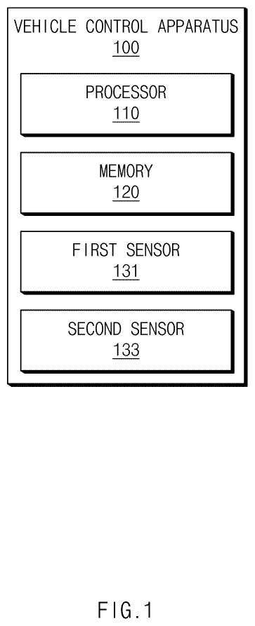

Hereinafter, various embodiments of the present disclosure will be described in detail with reference to FIGS. 1 to 11.

FIG. 1 shows an example of a block diagram associated with a vehicle control apparatus, according to an embodiment of the present disclosure.

Referring to FIG. 1, a vehicle control apparatus 100 according to an embodiment of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an embodiment may include a processor 110, a memory 120, a first sensor 131, and a second sensor 133. The processor 110, the memory 120, the first sensor 131, or the second sensor 133 may be electrically and/or operably coupled with each other by an electronic component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an embodiment is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an embodiment may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The memory 120 included in the vehicle control apparatus 100 according to an embodiment may include a hardware component for storing data and/or instructions that are to be input and/or output to the processor 110 of the vehicle control apparatus 100.

For example, the memory 120 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

For example, one or more instructions (or instructions) indicating an arithmetic operation and/or an operation to be performed on data by the processor 110 of the vehicle control apparatus 100 may be stored in the memory 120 of the vehicle control apparatus 100. A set of one or more instructions may be referred to as a “program,” “firmware,” an “operating system,” a “process,” a “routine,” a “sub-routine,” and/or an “application.” Hereinafter, the fact that an application is installed in the vehicle control apparatus 100 may mean that the one or more instructions provided in a form of an application are stored in the memory 120, and may mean that the one or more applications are stored in a format (e.g., a file with an extension specified by the operating system of the vehicle control apparatus 100) that is executable by a processor of an electronic device.

For example, the memory 120 may include one or more neural network models. For example, the memory 120 may include a first neural network model and a second neural network model. The first neural network model described later may include an object detection model. For example, the first neural network model including the object detection model may enter first sensor data and/or second sensor data, which is obtained by the first sensor 131 and/or the second sensor 133. Descriptions of the first sensor data and/or the second sensor data will be given later.

The first neural network model may output first object data corresponding to the first sensor data based on the first sensor data being entered. For example, the first object data may include location information of the detected object and/or classification (or type) information of the object. For example, the first object data may be expressed in a format including ‘[x, y, w, h, cls]’.

The second neural network model may output second object data corresponding to the second sensor data based on the second sensor data being entered. For example, the second object data may include location information of the detected object and/or classification (or type) information of the object. For example, the second object data may be expressed in a format including ‘[x, y, w, h, cls]’.

For example, in ‘[x, y, w, h, cls]’ expressed by the first object data, and/or second object data, [x] may mean an x-coordinate, [y] may mean a y-coordinate, [w] may mean a width of a bounding box corresponding to an external object, [h] may mean a length of the bounding box corresponding to the external object, and [cls] may mean the classification (or type) of the external object.

In an embodiment, the second neural network model may include an ensemble-based meta model. For example, the ensemble-based meta model may include a voting type, a bagging type, and/or a boosting type. For example, the second neural network model may include a multi-layer perceptron neural network.

The voting type may include a method of determining a final prediction result through voting among classifiers with different algorithms. For example, the voting type may include a hard voting type and/or a soft voting type.

The hard voting type may refer to a method according to the principle of majority voting and may include the type in which most results among results of classifiers are output. For example, the soft voting type may include a type in which the result with the highest probability is output as the result based on each average after the probability output from a classifier is added.

The bagging type may be short for bootstrap aggregating, and may include a method of generating pieces of bootstrap data for the obtained data, modeling pieces of data, and generating a final prediction model based on combining the pieces of modeled data.

The boosting type may include a method of generating new classification rules based on misclassified objects. For example, the boosting type may include a method in which types of external objects are better classified by assigning different weights to external objects represented as raw data.

The first sensor 131 and/or the second sensor 133 included in the vehicle control apparatus 100 according to an embodiment may identify an external object. For example, the processor 110 of the vehicle control apparatus 100 may detect the external object by using the first sensor 131 and/or the second sensor 133.

In an embodiment, the processor 110 may obtain first sensor data through the first sensor 131. Likewise, the processor 110 may obtain second sensor data through the second sensor 133.

The first sensor 131 may include a light detection and ranging (LiDAR), RADAR, and/or a camera. For example, the first sensor 131 may include a depth sensor.

The second sensor 133 may include a LiDAR, RADAR, and/or a camera. For example, the second sensor 133 may include a depth sensor.

In an embodiment, the first sensor 131 and the second sensor 133 may be different from each other. For example, if the first sensor 131 is the LiDAR, the second sensor 133 may be the RADAR and/or the camera that is different from the LiDAR.

The depth sensor described above may include at least one of a time of flight (ToF) sensor, structured light, an ultrasonic sensor, an infrared sensor, or an optical distance sensor, or any combination thereof.

For example, the above-described LiDAR may obtain data sets from identifying objects surrounding the vehicle control apparatus 100. For example, the LiDAR may identify at least one of a location of the surrounding object, a movement direction of the surrounding object, or a speed of the surrounding object, or any combination thereof based on a pulse laser signal emitted from the LiDAR being reflected by the surrounding object and returned.

For example, the LiDAR may obtain data sets for expressing an external object in the space defined by a first axis, a second axis, and a third axis based on a pulse laser signal reflected from surrounding objects. For example, the LiDAR may obtain data sets including a plurality of points corresponding to a surrounding object in the space, which is formed by the first axis, the second axis, and the third axis, based on receiving the pulse laser signal at a specified period.

The processor 110 may obtain data sets including a plurality of points based on the time required to transmit light emitted from the vehicle and the time required to receive light reflected back to the vehicle. The processor 110 may obtain data sets for expressing a plurality of points in a three-dimensional virtual coordinate system including the first axis, the second axis, and the third axis.

For example, the first axis may include the x-axis, the second axis may include the y-axis, and the third axis may include the z-axis. For example, the first axis, the second axis, and the third axis may be perpendicular to each other and may intersect each other based on an origin point. The first axis, the second axis, and the third axis are not limited to the above examples. Hereinafter, for convenience of description, the first axis is described as the x-axis; the second axis is described as the y-axis; and the third axis is described as the z-axis.

For example, the above-described camera may include one or more optical sensors (e.g., a charged coupled device (CCD) sensor and a complementary metal oxide semiconductor (CMOS) sensor) that generate electrical signals indicating the color and/or brightness of light.

Each of the one or more optical sensors included in the camera may obtain electrical signals from a plurality of optical sensors substantially simultaneously and may generate images or frames, each of which correspond to light reaching optical sensors arranged in a form of 2-dimensional grids and each of which include a plurality of pixels arranged in two dimensions.

Photo data captured by using the camera may refer to a plurality of images obtained from the camera. For example, video data captured by using the camera may mean the sequence of a plurality of images obtained from the camera at a specified frame rate.

The first sensor 131 may obtain first sensor data based on identifying (or detecting) an external object. For example, the first sensor data may include raw data obtained through the first sensor 131. The first sensor data obtained by the first sensor 131 described above may include at least one of a first location of the external object, a first heading direction corresponding to a direction in which an external object is driving, a first speed of the external object, or a first size of the external object, or any combination thereof.

The second sensor 133 may obtain second sensor data based on identifying (or detecting) an external object. For example, the second sensor data may include raw data obtained through the second sensor 133. The second sensor data obtained by the second sensor 133 described above may include at least one of a second location of the external object, a second heading direction corresponding to a direction in which an external object is driving, a second speed of the external object, or a second size of the external object, or any combination thereof.

For example, if the first bounding box corresponding to an external object is expressed in a two-dimensional virtual coordinate system based on the first sensor data, the first location described above may be expressed by using an x-coordinate and y-coordinate of the first bounding box.

Likewise, if the second bounding box corresponding to an external object is expressed in a two-dimensional virtual coordinate system based on the second sensor data, the second location described above may be expressed by using an x-coordinate and y-coordinate of the second bounding box.

In an embodiment, the processor 110 may enter, into the first neural network model, the first sensor data obtained through the first sensor 131 and the second sensor data obtained through the second sensor 133.

For example, the processor 110 may obtain first object data corresponding to the first sensor data and second object data corresponding to the second sensor data, which are used to predict at least one of a location of the external object, or the type of the external object, or any combination thereof, based on entering the first sensor data and the second sensor data into the first neural network model.

Each of the first object data and second sensor data may be expressed in a format of ‘[x, y, w, h, cls]’. For example, [x] may mean an x-coordinate if the bounding box corresponding to the external object is expressed in a two-dimensional virtual coordinate system, [y] may mean a y-coordinate if the bounding box corresponding to the external object is expressed in a two-dimensional virtual coordinate system, [w] may mean a width if the bounding box corresponding to the external object is expressed in a two-dimensional virtual coordinate system, [h] may mean a length if the bounding box corresponding to the external object is expressed in a two-dimensional virtual coordinate system, and [cls] may mean the type of the external object.

In an embodiment, the processor 110 may select at least one of first object data, or second object data, or any combination thereof as input data to be entered to the second neural network model based on at least one of a distance between a first location of the external object and a second location of the external object included in each of the first object data and the second object data, or the reliability of each of the first object data and the second object data, or any combination thereof.

For example, the first object data may be referred to as main data and/or sub data, or the second object data may be referred to as main data and/or sub data.

For example, if the first object data is main data, the second object data may mean sub data. Alternatively, if the first object data is sub data, the second object data may mean main data. Whether each of the first object data and the second object data is main data or sub data may be specified in advance.

At least one of the first object data or the second object data may be selected as main data based on the accuracy of the first sensor 131 and the accuracy of the second sensor 133, in an embodiment. For example, if the accuracy of the first sensor data obtained by the first sensor 131 is higher than the accuracy of the second sensor data obtained by the second sensor 133, the first object data may be selected as main data. If the first object data is selected as main data, the second object data may be selected as sub data.

The first location of the above-mentioned external object may be identified based on the first object data, in an embodiment. For example, the first location of the external object may include the location of the first bounding box generated by the first sensor data. For example, the first location of an external object may be identified based on the x-coordinate and y-coordinate of the first bounding box.

The second location of the above-mentioned external object may be identified based on the second object data. For example, the second location of the external object may include the location of the second bounding box generated by the second sensor data. For example, the second location of an external object may be identified based on the x-coordinate and y-coordinate of the second bounding box, for instance.

In an embodiment, the processor 110 may enter the selected input data into the second neural network model based on selecting at least one of the first object data, or the second object data, or any combination thereof as input data to be entered into the second neural network model.

For example, the processor 110 may obtain output data as at least one of a final location of the external object, or a final type of the external object, or any combination thereof based on entering the selected input data into the second neural network model. For example, the processor 110 may output the obtained output data.

In an embodiment, the processor 110 may identify a first location indicating a center point of the first bounding box. The processor 110 may identify a second location indicating a center point of the second bounding box. The processor 110 may identify a distance between the first location and the second location. The processor 110 may determine whether the distance between the first location and the second location exceeds a reference distance.

In an embodiment, the processor 110 may identify a first bounding box generated by the first object data. The processor 110 may identify the second bounding box generated by the second object data.

For example, the first bounding box may include a box, which corresponds to an external object and is used to represent the external object in a two-dimensional virtual coordinate system. For example, the first bounding box may include a box for expressing an external object in a two-dimensional virtual coordinate system based on first object data and/or first sensor data obtained through the first sensor 131.

The second bounding box may include a box, which corresponds to an external object and is used to represent the external object in a two-dimensional virtual coordinate system. For example, the second bounding box may include a box for expressing an external object in a two-dimensional virtual coordinate system based on second object data and/or second sensor data obtained through the second sensor 133.

The processor 110 may remove the first object data and the second object data based on the distance between the first location and the second location exceeding the reference distance, in an embodiment. For example, the processor 110 may not select first object data and second object data as input data based on a distance between the first location and the second location exceeding the reference distance. For example, the processor 110 may select third object data obtained by using a sensor different from the first sensor 131 and the second sensor 133 as input data based on removing first object data and second object data.

For example, the processor 110 may identify the first reliability of the first object data based on the distance between the first location and the second location being smaller than or equal to the reference distance. For example, the processor 110 may identify the second reliability of the second object data based on the distance between the first location and the second location being smaller than or equal to the reference distance. For example, the processor 110 may identify the first reliability of first object data and the second reliability of second object data based on the distance between the first location and the second location being smaller than or equal to the reference distance.

In an embodiment, the processor 110 may determine whether the first reliability of the first object data and/or the second reliability of the second object data exceed the reference reliability, based on the distance between the first location and the second location being smaller than or equal to the reference distance.

For example, the first reliability and/or the second reliability may be identified by a bounding box corresponding to the external object at a time point before the first object data and/or second object data are obtained.

In an embodiment, the processor 110 may select at least one of the first object data, or the second object data, or any combination thereof as input data based on whether the first reliability of the first object data and the second reliability of the second object data exceed the reference reliability.

For example, the processor 110 may identify the second reliability of the second object data based on the first reliability of the first object data exceeding the reference reliability. The processor 110 may select the first object data and the second object data as input data based on the second reliability of the second object data exceeding the reference reliability.

For example, the processor 110 may identify the second reliability of the second object data based on the first reliability of the first object data being smaller than or equal to the reference reliability. The processor 110 may select the second object data as input data based on the second reliability of the second object data exceeding the reference reliability.

In an embodiment, the processor 110 may remove the first object data and second object data based on the fact that the second reliability of the second object data is smaller than or equal to the reference reliability. In detail, the processor 110 may remove first object data and second object data based on the fact that the first reliability of the first object data and the second reliability of the second object data are smaller than or equal to the reference reliability. For example, the processor 110 may not select first object data and second object data as input data based on the fact that the first reliability of the first object data and the second reliability of the second object data are smaller than or equal to the reference reliability.

In an embodiment, the processor 110 may identify a first bounding box, which is generated by the first object data and which corresponds to an external object, and a second bounding box, which is generated by the second object data and which corresponds to the external object.

For example, the processor 110 may identify an area where the first bounding box overlaps the second bounding box. The processor 110 may train a second neural network model based on an area where the first bounding box overlaps the second bounding box, or may select at least one of the first object data, or the second object data, or any combination thereof as input data.

In an embodiment, the processor 110 may identify data uncertainty for input data based on the first sensor data and the second sensor data. For example, the processor 110 may identify model uncertainty for the second neural network model based on a third neural network model different from the second neural network model. For example, the third neural network model may include a mixture density network (MDN). For example, the MDN may be a decoder model and may include a plurality of layers. For example, the processor 110 may estimate uncertainty by using prediction data (e.g., output data) included in the plurality of layers included in the MDN.

The processor 110 may expand the prediction data (e.g., output data) based on layers for estimating a weight and variance of a probability distribution,

For example, the processor 110 may identify model uncertainty for the second neural network model by using at least one of the weight of the probability distribution, the mean of the probability distribution, or the variance of the probability distribution, or any combination thereof.

For example, the processor 110 may obtain output data based on input data, to which the data uncertainty is applied, and a second neural network model, to which the model uncertainty is applied. For example, the processor 110 may enter input data, to which the data uncertainty is applied, into the second neural network model to which model uncertainty is applied. The processor 110 may obtain output data from the second neural network model based on the fact that the input data to which the data uncertainty is applied is entered into the second neural network model to which model uncertainty is applied. The processor 110 may output the obtained output data.

As described above, the processor 110 of the vehicle control apparatus 100 according to an embodiment may accurately identify the external object by identifying the external object based on sensor data obtained by using a plurality of sensors

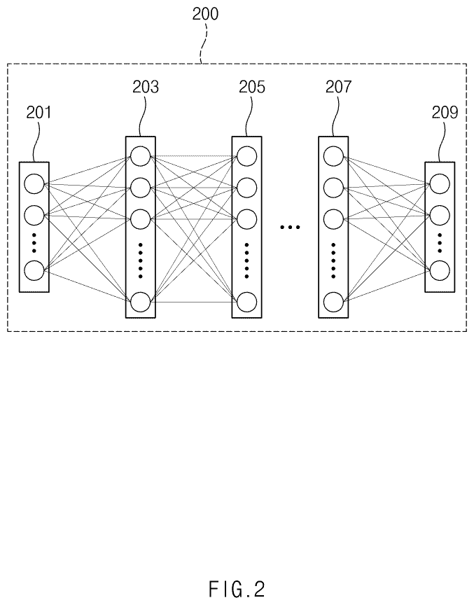

FIG. 2 shows an example of a first neural network model and/or a second neural network model, according to an embodiment of the present disclosure.

Referring to FIG. 2, a memory (e.g., the memory 120 in FIG. 1) of a vehicle control apparatus (e.g., the vehicle control apparatus 100 in FIG. 1) according to an embodiment may include a first neural network model and a second neural network model. Hereinafter, a neural network model 200 may include a first neural network model, and/or a second neural network model.

In an embodiment, the neural network model 200 may include an input layer 201, hidden layers 203, 205, and 207, and an output layer 209. For example, the input layer 201 may include input neurons. For example, each of the hidden layers 203, 205, and 207 may include hidden neurons. For example, the output layer 209 may include output neurons.

At least one of the input neurons, the hidden neurons, or the output neurons, or any combination thereof may be changed by a user.

The neural network model 200 may include a loss function. For example, the neural network model may include a cost function. The loss function and the cost function may be substantially the same as each other, in an embodiment.

The loss function may be used to minimize the normalization of the bounding box. For example, the loss function may be used to minimize cross-entropy.

The processor (e.g., the processor 110 in FIG. 1) may train the neural network model 200. For example, the processor may train the neural network model 200 based on input data selected from at least one of the first object data, or the second object data, or any combination thereof. For example, the processor may train the neural network model 200 based on at least one of input data, output data obtained by the neural network model 200, the loss function, or a ground-truth, or any combination thereof.

For example, the ground-truth may include actual information corresponding to training data for training the neural network model 200. For example, the actual information may include at least one of actual location information of an external object included in the training data for training the neural network model 200, or classification information of the above-described external object, or any combination thereof.

As described above, the processor of the vehicle control apparatus according to an embodiment may train the neural network model 200 by using various parameters. The processor may obtain output data with relatively accurate location and size by obtaining the output data corresponding to the external object by using the neural network model 200 based on training the neural network model 200 by using various parameters.

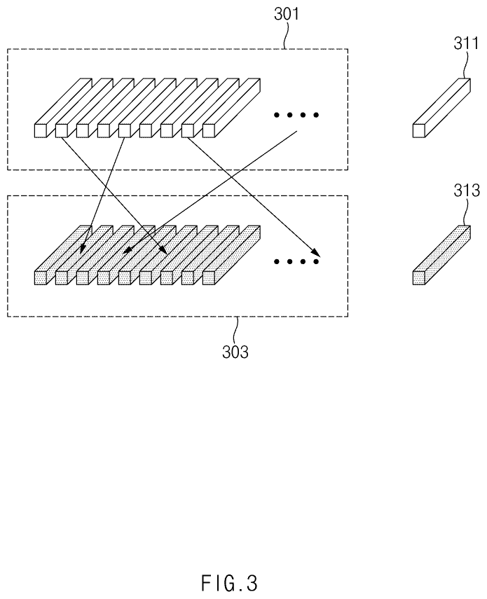

FIG. 3 shows an example of first object data and second object data, in an embodiment of the present disclosure.

Referring to FIG. 3, a processor (e.g., the processor 110 in FIG. 1) of a vehicle control apparatus (e.g., the vehicle control apparatus 100 in FIG. 1) according to an embodiment may obtain first sensor data 301 through a first sensor (e.g., the first sensor 131 in FIG. 1). The processor may obtain second sensor data 303 through the second sensor (e.g., the second sensor 133 in FIG. 1).

In an embodiment, the processor may obtain first object data 311 based on entering the first sensor data 301 into a first neural network model stored in a memory (e.g., the memory 120 in FIG. 1). For example, the first object data 311 may be expressed in a format of [x_1, y_1, w_1, h_1, cls_1].

In an embodiment, the processor may obtain second object data 313 based on entering the second sensor data 303 into the first neural network model stored in the memory. For example, the second object data 313 may be expressed in a format of [x_2, y_2, w_2, h_2, cls_2].

For example, [x_1] included in the first object data 311 may mean an x-coordinate of a first location. [y_1] included in the first object data 311 may mean a y-coordinate of the first location. [w_1] included in the first object data 311 may mean a width of a first bounding box. [h_1] included in the first object data 311 may mean a length of the first bounding box. [cls_1] included in the first object data 311 may include the type of an external object identified by a first sensor.

For example, [x_2] included in the second object data 313 may mean an x-coordinate of a second location. [y_2] included in the second object data 313 may mean a y-coordinate of the second location. [w_2] included in the second object data 313 may mean the width of a second bounding box. [h_2] included in the second object data 313 may mean the length of the second bounding box. [cls_2] included in the second object data 313 may include the type of an external object identified by a second sensor.

In an embodiment, the processor may identify the first location indicating a location of the external object included in the first object data. For example, the first location may include coordinates of a center point of the first bounding box corresponding to the external object expressed in a two-dimensional virtual coordinate system.

Likewise, the processor may identify the second location indicating a location of the external object included in the second object data. For example, the second location may include coordinates of a center point of the second bounding box corresponding to the external object expressed in a two-dimensional virtual coordinate system.

In an embodiment, the processor may obtain an optimal value of a distance between the first location and the second location. The processor may remove false pairs depending on a threshold value based on obtaining the optimal value of the distance between the first location and the second location. For example, the processor may remove false pairs included in at least one of the first object data 311, or the second object data 313, or any combination thereof based on obtaining the optimal value of the distance between the first location and the second location.

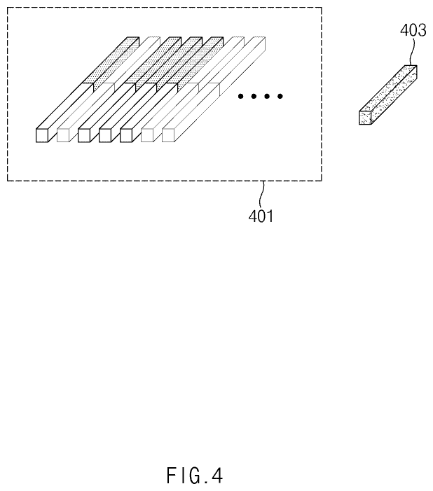

FIG. 4 shows an example of removing data with relatively low reliability, in an embodiment of the present disclosure.

Referring to FIG. 4, a processor (e.g., the processor 110 in FIG. 1) of a vehicle control apparatus (e.g., the vehicle control apparatus 100 in FIG. 1) according to an embodiment may obtain first sensor data through a first sensor (e.g., the first sensor 131 in FIG. 1). The processor may obtain second sensor data through a second sensor (e.g., the second sensor 133 in FIG. 1).

In an embodiment, the processor may perform a semantic masking process based on the reliability of the object data 401. The following descriptions may include an example of a semantic masking process performed by the processor.

In an embodiment, the processor may obtain first object data based on entering first sensor data into a first neural network model. The processor may obtain second object data based on entering second sensor data into the first neural network model. The object data 401 described later may include the first object data and the second object data. For example, the object data 401 may be referred to as “prediction data”.

In an embodiment, the processor may identify the reliability of the object data 401. For example, the processor may determine whether the reliability of the object data 401 exceeds reference reliability.

The processor may select the object data 401 as input data to be entered into the second neural network model based on the reliability of the object data 401 exceeding the reference reliability.

The processor may remove object data 403, whose reliability is smaller than or equal to reference reliability, from among the object data 401 based on the reliability of the object data 401 being smaller than or equal to the reference reliability. For example, the removed object data 403 may not be entered into the second neural network model.

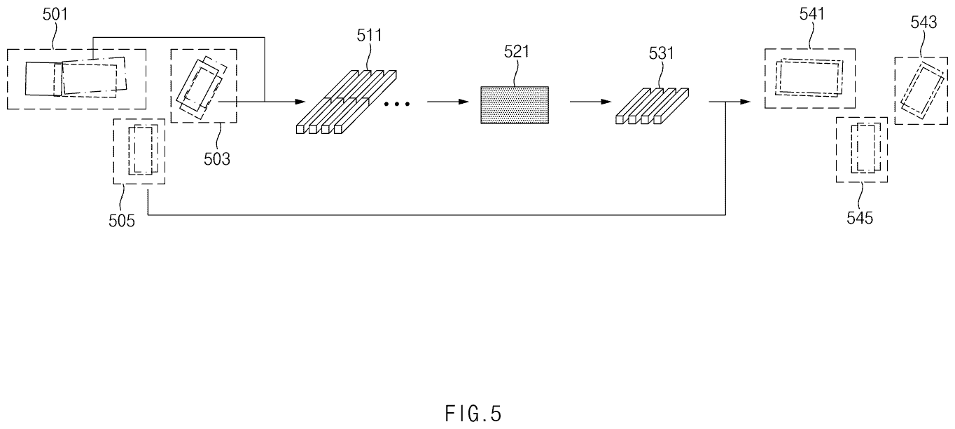

FIG. 5 shows an example of obtaining output data, in an embodiment of the present disclosure.

Referring to FIG. 5, a processor (e.g., the processor 110 in FIG. 1) of a vehicle control apparatus (e.g., the vehicle control apparatus 100 in FIG. 1) according to an embodiment may obtain first sensor data through a first sensor (e.g., the first sensor 131 in FIG. 1) and may obtain second sensor data through a second sensor (e.g., the second sensor 133 in FIG. 1).

For example, the processor may obtain first object data based on entering first sensor data into a first neural network model, and may obtain second object data based on entering second sensor data into the first neural network model.

The processor may select at least one of first object data, or second object data, or any combination thereof as input data 511 to be entered into a second neural network model 521.

Hereinafter, an example of obtaining output data 531 by entering input data 511 into the second neural network model 521 based on selecting at least one of first input data 501, second input data 503, or third input data 505, or any combination thereof as the input data 511 will be described later.

In an embodiment, the processor may select the first input data 501 as the input data 511. For example, the input data 511 may be expressed in a tensor format.

For example, the processor may obtain the output data 531 based on entering the first input data 501, which is selected as the input data 511, into the second neural network model 521. The output data 531 may be expressed in the tensor format described above. For example, if selecting the first input data 501 as the input data 511, the processor may identify information of pieces of object data included in the first input data 501. The processor may select relatively accurate information from among the information of pieces of object data included in the first input data 501 and may select the selected information as the input data 511. The processor may enter the input data 511 into the second neural network model 521 based on selecting the first input data 501 including relatively accurate information as the input data 511.

In an embodiment, the processor may select the second input data 503 as the input data 511.

For example, the processor may obtain the output data 531 based on entering the second input data 503, which is selected as the input data 511, into the second neural network model 521. For example, if selecting the second input data 503 as the input data 511, the processor may identify information of pieces of object data included in the second input data 503. The processor may select relatively accurate information from among the information of pieces of object data included in the second input data 503 and may select the selected information as the input data 511. The processor may enter the input data 511 into the second neural network model 521 based on selecting the second input data 503 including relatively accurate information as the input data 511.

In an embodiment, the processor may select the third input data 505 as the input data 511.

For example, the processor may obtain the third input data 505 based on removing object data whose reliability is smaller than or equal to reference reliability, from among first object data and second object data. The processor may enter the input data 511 into the second neural network model 521 based on selecting the third input data 505 as the input data 511.

In an embodiment, the processor may obtain the output data 531 from the second neural network model 521. For example, the output data 531 may be expressed in the tensor format.

For example, the processor may express the output data 531 expressed in the tensor format as a bounding box corresponding to an external object. For example, the processor may obtain a first bounding box 541 based on the first input data 501. Likewise, the processor may obtain a second bounding box 543 based on the second input data 503. Likewise, the processor may obtain a third bounding box 545 based on the third input data 505.

The first bounding box 541 and the second bounding box 543 may include a bounding box precisely predicted by selecting information with relatively high accuracy from among various pieces of information.

The third bounding box 545 may include an example of outputting final prediction data based on prediction data from a sensor with high reliability.

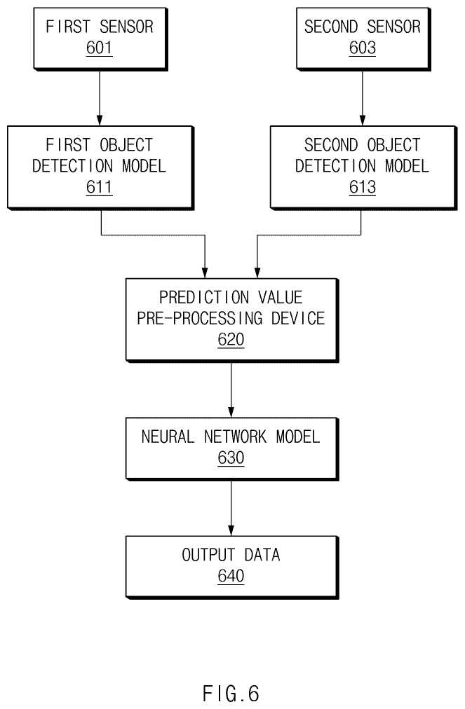

FIG. 6 shows an example of outputting output data, in an embodiment of the present disclosure.

Referring to FIG. 6, a processor (e.g., the processor 110 in FIG. 1) of a vehicle control apparatus (e.g., the vehicle control apparatus 100 in FIG. 1) according to an embodiment may obtain first sensor data 601 through a first sensor (e.g., the first sensor 131 in FIG. 1). The processor may obtain second sensor data 603 through the second sensor (e.g., the second sensor 133 in FIG. 1).

In an embodiment, the processor may enter first sensor data 601 into a first object detection model 611. The processor may enter second sensor data 603 into a second object detection model 613.

The first sensor data 601 may include raw data obtained from a first sensor. For example, the second sensor data 603 may include raw data obtained from a second sensor.

The first object detection model 611 and/or the second object detection model 613 may be included in the first neural network model described in FIG. 1, in an embodiment. Each of the first object detection model 611 and/or the second object detection model 613 may be a neural network model, and may include a model for identifying at least one of a location of an external object, the type of the external object, a heading direction corresponding to a traveling direction of the external object, or a speed of the external object, or any combination thereof.

In an embodiment, the processor may obtain first object data from the first object detection model 611. The processor may obtain second object data from the second object detection model 613. For example, the first object data may include data obtained by processing the first sensor data 601. For example, the second object data may include data obtained by processing the second sensor data 603.

The first object data, and/or the second object data may include a prediction value for predicting at least one of the location of the external object, the type of the external object, the heading direction corresponding to the traveling direction of the external object, or the speed of the external object, or any combination thereof.

In an embodiment, the processor may enter the first object data and the second object data into a prediction value pre-processing device 620. For example, the prediction value pre-processing device 620 may include a device for selecting input data to be entered into a neural network model 630 based on at least one of a distance between a first location of the external object included in the first object data and a second location of the external object included in the second object data, or the reliability of each of the first object data and the second object data, or any combination thereof. For example, the neural network model 630 may include the second neural network model described in FIG. 1.

In an embodiment, the processor may enter at least one of the first object data, or the second object data, or any combination thereof, which is selected as the selected input data, into the neural network model 630 based on the prediction value pre-processing device 620.

For example, the processor may obtain output data 640 based on input data into the neural network model 630. For example, the output data 640 may include at least one of a final bounding box corresponding to the external object, a final location corresponding to a location of the external object, a final type corresponding to the type of the external object, a final heading direction corresponding to the traveling direction of the external object, or a final speed corresponding to the speed of the external object, or any combination thereof.

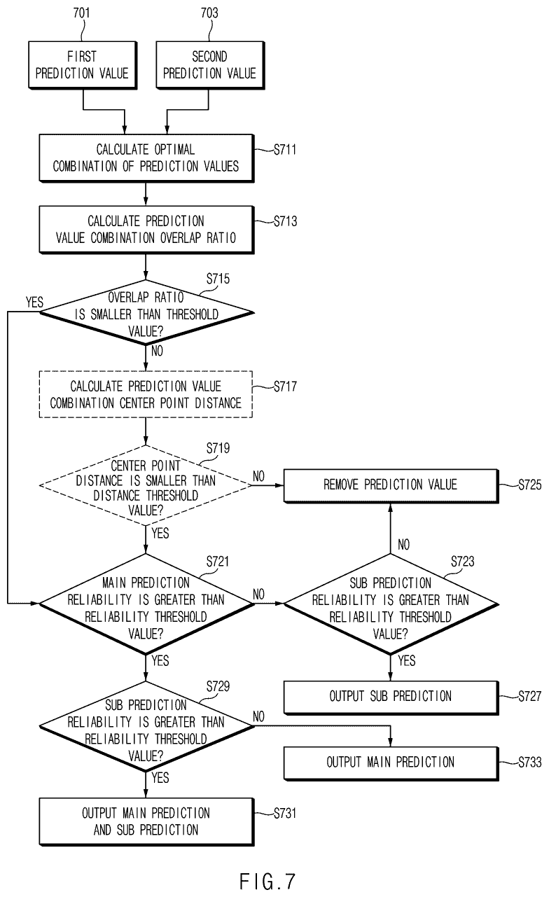

FIG. 7 shows an example of a flowchart associated with a vehicle control method, according to an embodiment of the present disclosure.

Hereinafter, it is assumed that the vehicle control apparatus 100 of FIG. 1 performs the process of FIG. 7. In addition, in a description of FIG. 7, it may be understood that an operation described as being performed by an apparatus is controlled by the processor 110 of the vehicle control apparatus 100.

At least one of the operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, a vehicle control method according to one embodiment may include an operation of obtaining a first prediction value 701 and a second prediction value 703. For example, the vehicle control method may include an operation of obtaining first sensor data through a first sensor (e.g., the first sensor 131 in FIG. 1). Likewise, the vehicle control method may include an operation of obtaining second sensor data through a second sensor (e.g., the second sensor 133 in FIG. 1). For example, the vehicle control method may include an operation of obtaining a first prediction value 701 based on entering the first sensor data into the first neural network model, and/or the vehicle control method may include an operation of obtaining a second prediction value 703 based on entering the second sensor data into the second neural network model. For example, the first prediction value 701 may be referred to as the first object data described in FIG. 1. For example, the second prediction value 703 may be referred to as the second object data described in reference to FIG. 1.

In operation S711, the vehicle control method according to an embodiment may include an operation of calculating an optimal combination of prediction values. For example, the vehicle control method may include an operation of calculating the optimal combination based on pieces of information included in the prediction values.

In operation S713, the vehicle control method according to an embodiment may include an operation of calculating a prediction value combination overlap ratio. For example, the vehicle control method may include an operation of calculating a ratio at which a first bounding box generated by the first prediction value 701 overlaps a second bounding box generated by the second prediction value 703.

In operation S715, the vehicle control method according to an embodiment may include an operation of determining whether the overlap ratio is smaller than a threshold value. For example, the overlap ratio may include a ratio, at which the first bounding box overlaps the second bounding box and which is calculated in operation S713.

If the overlap ratio is not smaller than a threshold value (No in operation S715), in operation S717, the vehicle control method according to an embodiment may include an operation of calculating a prediction value combination center point distance. For example, the vehicle control method may include an operation of identifying a distance between a first center point of the first bounding box generated by the first prediction value 701 and a second center point of the second bounding box generated by the second prediction value 703.

In operation S719, the vehicle control method according to an embodiment may include an operation of determining whether the center point distance is smaller than a distance threshold value. For example, the vehicle control method may include an operation of determining whether the distance between the first center point and the second center point identified in operation S717 is smaller than the distance threshold value.

According to an embodiment, operation S717 and operation S719 may be omitted.

If the overlap ratio is smaller than the threshold value (Yes in operation S715), in operation S721, the vehicle control method according to an embodiment may include an operation of determining whether main prediction reliability is greater than a reliability threshold value. For example, the main prediction reliability may include the reliability of a prediction value, whose reliability is set to be relatively high, from among the first reliability of the first prediction value 701 and the second reliability of the second prediction value 703.

If the main prediction reliability is not greater than the reliability threshold value (No in operation S721), in operation S723, the vehicle control method according to an embodiment may include an operation of determining whether sub prediction reliability is greater than the reliability threshold value. For example, the sub prediction reliability may include the reliability of a prediction value, whose reliability is set to be relatively low, from among the first reliability of the first prediction value 701 and the second reliability of the second prediction value 703.

If the center point distance is not smaller than the distance threshold value (No in operation S719), or the sub prediction reliability is not greater than the reliability threshold value (No in operation S723), in operation S725, the vehicle control method according to an embodiment may include an operation of removing a prediction value. If the prediction value is removed, the vehicle control method may include an operation of outputting a prediction value corresponding to an external object by using a prediction value obtained at a second time point before the first time point at which the prediction value was obtained. For another example, if the prediction value is removed, the vehicle control method may output the third prediction value described above by using the third prediction value that is different from the first prediction value 701 and the second prediction value 703.

If the sub prediction reliability is greater than the reliability threshold value (Yes in operation S723), in operation S727, the vehicle control method according to an embodiment may include an operation of outputting sub prediction. For example, if the main prediction reliability is not greater than the reliability threshold value and the sub prediction reliability is greater than the reliability threshold value, the vehicle control method may include an operation of not outputting main prediction, but outputting the sub prediction.

If the main prediction reliability is greater than the reliability threshold value (Yes in operation S721), in operation S729, the vehicle control method according to an embodiment may include an operation of determining whether sub prediction reliability is greater than the reliability threshold value. Operation S729 may be substantially the same as operation S723.

If the sub prediction reliability is greater than the reliability threshold value (Yes in operation S729), in operation S731, the vehicle control method according to an embodiment may include an operation of outputting the main prediction and the sub prediction. For example, if both the main prediction reliability and the sub prediction reliability are greater than the reliability threshold value, the vehicle control method may include an operation of outputting the main prediction and the sub prediction.

If the sub prediction reliability is not greater than the reliability threshold value (No in operation S729), in operation S733, the vehicle control method according to an embodiment may include an operation of outputting the main prediction. For example, if the main prediction reliability is greater than the reliability threshold value and the sub prediction reliability is not greater than the reliability threshold value, the vehicle control method may include an operation of not outputting the sub prediction, but outputting the main prediction.

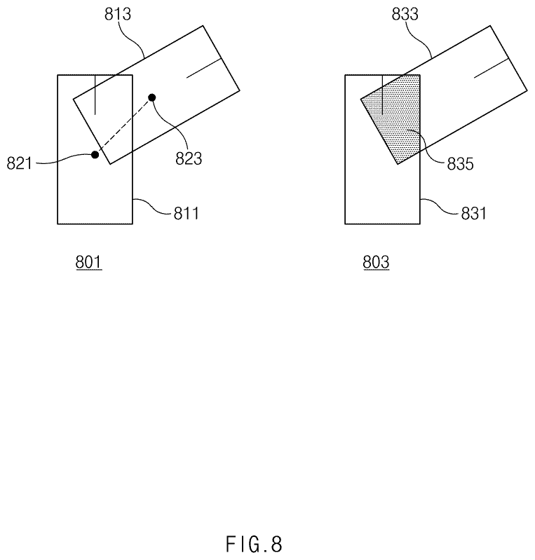

FIG. 8 shows an example of a process using a distance between center points of bounding boxes, or an area in which bounding boxes overlap each other, in an embodiment of the present disclosure.

Referring to FIG. 8, a processor (e.g., the processor 110 in FIG. 1) of a vehicle control apparatus (e.g., the vehicle control apparatus 100 of FIG. 1) according to an embodiment may obtain first object data and/or second object data based on a first neural network model.

A first example 801 in FIG. 8 may include an example of identifying a distance between a first center point of a first bounding box 811 generated by the first object data and a second center point of a second bounding box 813 generated by the second object data.

A second example 803 in FIG. 8 may include an example of identifying an area where a third bounding box 831 created by the first object data overlaps a fourth bounding box 833 created by the second object data.

Referring to the first example 801 in FIG. 8, in an embodiment, the processor may identify a first center point 821 of the first bounding box 811, and/or the processor may identify a second center point 823 of the second bounding box 813.

The processor may identify a distance between the first center point 821 and the second center point 823, in an embodiment. For example, the processor may select at least one of the first object data, or the second object data, or any combination thereof as input data to be entered into a second neural network model based on identifying the distance between the first center point 821 and the second center point 823.

Referring to the second example 803 in FIG. 8, in an embodiment, the processor may identify the third bounding box 831 and the fourth bounding box 833. For example, the third bounding box 831 may be substantially the same as the first bounding box 811. For example, the fourth bounding box 833 may be substantially the same as the second bounding box 813.

In an embodiment, the processor may identify an area 835 where the third bounding box 831 overlaps the fourth bounding box 833. For example, the processor may identify the ratio of the area 835 where the third bounding box 831 overlaps the fourth bounding box 833.

$${L}_{Box} = 1 - \vert \frac{{box}_{A} ⋂ {box}_{B}}{{box}_{A} ⋃ {box}_{B}} \vert \qquad [ Equation l ]$$

In Equation 1, box_{A} ∪ box_{B} may mean the sum of a first area of the third bounding box 831 and a second area of the fourth bounding box 833. In Equation 1, box_{A} ∩ box_{B} may mean the area 835 where the third bounding box 831 overlaps the fourth bounding box 833. L_{Box} may include a result value for training a second neural network model.

In an embodiment, the processor may train the second neural network model based on the result value for training the second neural network model obtained in Equation 1.

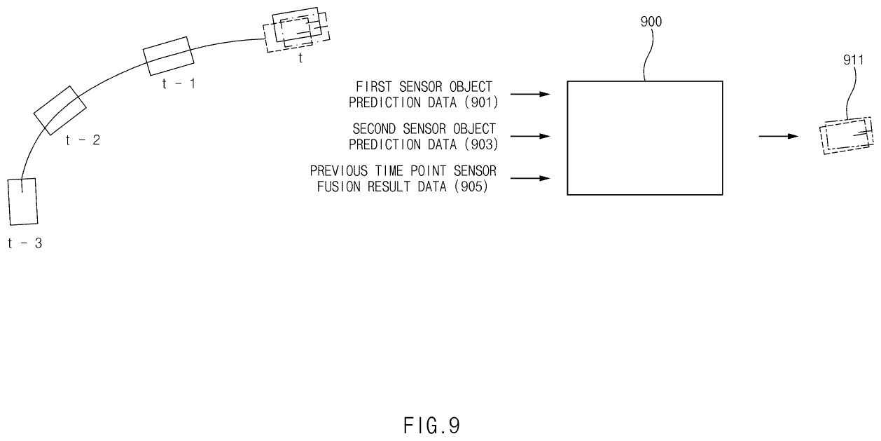

FIG. 9 shows an example of creating a bounding box corresponding to an external object by using data of a first time point and data of a second time point before the first time point, in an embodiment of the present disclosure.

Referring to FIG. 9, a processor (e.g., the processor 110 in FIG. 1) of a vehicle control apparatus (e.g., the vehicle control apparatus 100 in FIG. 1) according to an embodiment may obtain first sensor data through a first sensor (e.g., the first sensor 131 in FIG. 1). The processor may obtain second sensor data through a second sensor (e.g., the second sensor 133 in FIG. 1).

In an embodiment, the processor may obtain first object data and second object data based on entering the first sensor data and the second sensor data into a first neural network model.

For example, the first object data may be referred to as first sensor object prediction data 901 in FIG. 9. For example, the second object data may be referred to as second sensor object prediction data 903 in FIG. 9. For example, the first sensor object prediction data 901 and the second sensor object prediction data 903 may include data based on sensor data obtained at time point t.

In an embodiment, the processor may identify previous time point sensor fusion result data 905. For example, as illustrated in an example in FIG. 9, the previous time point sensor fusion result data 905 may include sensor fusion result data at each of time point t-3, time point t-2, and time point t-1.

In an embodiment, the processor may enter the first sensor object prediction data 901, the second sensor object prediction data 903, and the previous time point sensor fusion result data 905 into a neural network model 900. For example, the neural network model 900 may include the second neural network model described in FIG. 1.

In an embodiment, the processor may obtain output data for outputting a bounding box 911 corresponding to an external object based on entering the first sensor object prediction data 901, the second sensor object prediction data 903, and the previous time point sensor fusion result data 905 into the neural network model 900.

For example, the bounding box 911 corresponding to the external object may include a bounding box corresponding to the external object identified at time point t.

In an embodiment, the processor may output the bounding box 911 in response to obtaining output data for outputting the bounding box 911 corresponding to the external object. For example, the bounding box 911 may include information associated with at least one of a location corresponding to the external object, a heading direction corresponding to a direction in which the external object is driving, a size of the external object, or a speed of the external object, or any combination thereof.

As described above, the processor of the vehicle control apparatus according to an embodiment may accurately identify an external object by identifying the external object by using data from the first and second time points.

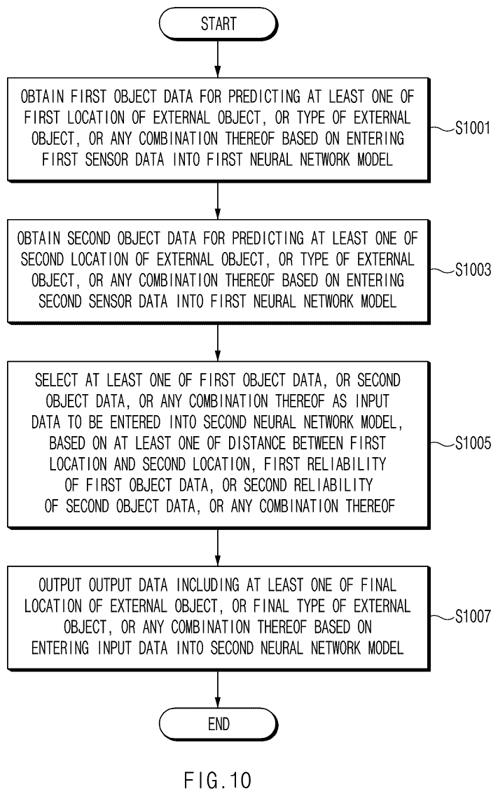

FIG. 10 shows an example of a flowchart associated with a vehicle control method, according to an embodiment of the present disclosure.

Hereinafter, it is assumed that the vehicle control apparatus 100 of FIG. 1 performs the process of FIG. 10. In addition, in a description of FIG. 10, it may be understood that an operation described as being performed by an apparatus is controlled by the processor 110 of the vehicle control apparatus 100.

At least one of operations of FIG. 10 may be performed by the vehicle control apparatus 100 of FIG. 1. Each of the operations in FIG. 10 may be performed sequentially, but is not necessarily sequentially performed. For example, the order of operations may be changed, and at least two operations may be performed in parallel.

Referring to FIG. 10, in operation S1001, a vehicle control method according to an embodiment may include an operation of obtaining first object data for predicting at least one of a first location of an external object, or the type of the external object, or any combination thereof based on entering first sensor data into a first neural network model.

In operation S1003, the vehicle control method according to an embodiment may include an operation of obtaining second object data for predicting at least one of a second location of an external object, or the type of the external object, or any combination thereof based on entering second sensor data into the first neural network model.

In operation S1005, the vehicle control method according to an embodiment may include an operation of selecting at least one of the first object data, or the second object data, or any combination thereof as input data to be entered into a second neural network model, based on at least one of a distance between the first location and the second location, first reliability of the first object data, or second reliability of the second object data, or any combination thereof.

For example, the vehicle control method may include an operation of selecting at least one of the first object data, or the second object data, or any combination thereof as input data based on whether the first reliability and the second reliability exceed reference reliability.

For example, the vehicle control method may include an operation of identifying second reliability based on first reliability exceeding reference reliability.

For example, the vehicle control method may include an operation of selecting first object data and second object data as input data based on the second reliability exceeding the reference reliability.

For example, the vehicle control method may include an operation of selecting first object data as input data based on the second reliability being smaller than or equal to the reference reliability.

In summary, the vehicle control method may include an operation of selecting first object data and second object data as input data based on the first reliability exceeding the reference reliability and the second reliability exceeding the reference reliability.

The vehicle control method may include an operation of selecting the first object data as input data without selecting the second object data as input data, based on the first reliability exceeding the reference reliability and the second reliability being smaller than or equal to the reference reliability.

For example, the vehicle control method may include an operation of identifying the second reliability based on the first reliability being smaller than or equal to the reference reliability.

For example, the vehicle control method according to an embodiment may include an operation of selecting the second object data as input data based on the second reliability exceeding the reference reliability.

For example, the vehicle control method according to an embodiment may include an operation of not selecting the first object data and the second object data as input data based on the second reliability being smaller than or equal to the reference reliability. The vehicle control method may include an operation of selecting, as input data, third object data, which is obtained at a second time point before the first time point at which the first object data and the second object data were obtained, if the first object data and the second object data are not selected as the input data.

In an embodiment, the vehicle control method may include an operation of identifying a distance between a first location, which is created by the first object data and which indicates a center point of the first bounding box corresponding to the external object, and a second location, which is created by the second object data and which indicates a center point of the second bounding box corresponding to the external object. The vehicle control method may include an operation of determining whether the distance between the first location and the second location exceeds a reference distance.

The vehicle control method according to an embodiment may include an operation of removing the first object data and the second object data based on the distance between the first location and the second location exceeding the reference distance.

For example, the vehicle control method may include an operation of determining whether the first reliability and the second reliability exceed reference reliability, based on a fact that the distance between the first location and the second location is smaller than or equal to the reference distance.

The vehicle control method according to an embodiment may include an operation of identifying a first bounding box, which is generated by the first object data and which corresponds to an external object, and a second bounding box, which is generated by the second object data and which corresponds to the external object.

For example, the vehicle control method may include an operation of identifying an area where the first bounding box overlaps the second bounding box.

The vehicle control method may include an operation of training the second neural network model based on the overlapped area, or selecting at least one of the first object data, or the second object data, or any combination thereof as the input data.

In operation S1007, the vehicle control method according to an embodiment may include an operation of outputting output data including at least one of a final location of the external object, or a final type of the external object, or any combination thereof based on entering input data into the second neural network model.

The vehicle control method according to an embodiment may include an operation of identifying data uncertainty for the input data based on the first sensor data and the second sensor data, which are entered into the first neural network model. The vehicle control method may include an operation of identifying model uncertainty for the second neural network model based on a third neural network model different from the second neural network model. The vehicle control method may include an operation of outputting the output data based on the input data, to which the data uncertainty is applied, and the second neural network model to which the model uncertainty is applied.

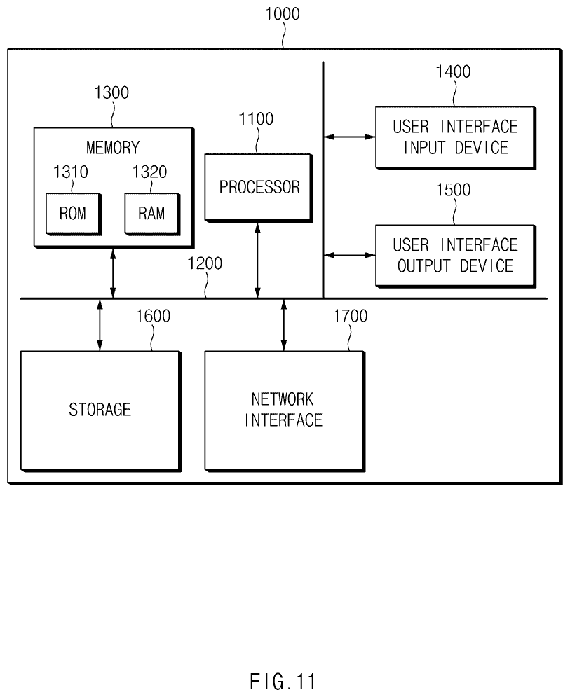

FIG. 11 shows a computing system related to a vehicle control apparatus or vehicle control method, according to an embodiment of the present disclosure.

Referring to FIG. 11, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

The present technology may accurately detect an external object by using sensor data obtained by various sensors.

Moreover, the present technology may accurately detect the external object by identifying the external object based on entering pieces of sensor data into a neural network model.

Furthermore, the present technology may accurately detect the external object under various conditions by detecting the external object by using various neural network models.

Besides, a variety of effects directly or indirectly understood through the present disclosure may be provided.

Hereinabove, although the present disclosure is described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control apparatus comprising:
a first sensor configured to obtain first sensor data based on identifying an external object;
a second sensor configured to obtain second sensor data based on identifying the external object;
a memory configured to store a first neural network model and a second neural network model; and
a processor,
wherein the processor is configured to:
obtain first object data for predicting at least one of a first location of the external object, or a type of the external object, or combinations thereof based on entering first sensor data into the first neural network model;
obtain second object data for predicting at least one of a second location of the external object, or the type of the external object, or combinations thereof based on entering the second sensor data into the first neural network model;
select at least one of the first object data, or the second object data, or combinations thereof as input data to be entered into the second neural network model, based on at least one of a distance between the first location and the second location, first reliability of the first object data, or second reliability of the second object data, or combinations thereof; and
output data including at least one of a final location of the external object, or a final type of the external object, or combinations thereof based on entering the input data into the second neural network model.

2. The vehicle control apparatus of claim 1, wherein the processor is configured to:
select at least one of the first object data, or the second object data, or combinations thereof as the input data based on whether the first reliability and the second reliability exceed reference reliability.

3. The vehicle control apparatus of claim 2, wherein the processor is configured to:
identify the second reliability based on the first reliability exceeding the reference reliability;
select the first object data and the second object data as the input data based on whether the second reliability exceeds the reference reliability; and
select the first object data as the input data based on the second reliability being smaller than or equal to the reference reliability.

4. The vehicle control apparatus of claim 2, wherein the processor is configured to:
identify the second reliability based on the first reliability being smaller than or equal to the reference reliability;
select the second object data as the input data, based on whether the second reliability exceeds the reference reliability;
remove the first object data and the second object data based on the second reliability being smaller than or equal to the reference reliability; and
select third object data, which is based on sensor data obtained by a third sensor different from the first sensor and the second sensor, as the input data.

5. The vehicle control apparatus of claim 1, wherein the processor is configured to:
identify the first location, which is generated by the first object data and which indicates a center point of a first bounding box corresponding to the external object;
identify the second location, which is generated by the second object data and which indicates a center point of a second bounding box corresponding to the external object; and
determine whether a distance between the first location and the second location exceeds a reference distance.

6. The vehicle control apparatus of claim 5, wherein the processor is configured to:
remove the first object data and the second object data based on the distance between the first location and the second location exceeding the reference distance; and
select third object data, which is based on sensor data obtained by a third sensor different from the first sensor and the second sensor, as the input data.

7. The vehicle control apparatus of claim 5, wherein the processor is configured to:
determine whether the first reliability and the second reliability exceed reference reliability, based on a fact that the distance between the first location and the second location is smaller than or equal to the reference distance.

8. The vehicle control apparatus of claim 1, wherein the processor is configured to:
identify a first bounding box, which is generated by the first object data and which corresponds to the external object;
identify a second bounding box, which is generated by the second object data and which corresponds to the external object;
identify an area where the first bounding box overlaps the second bounding box; and
train the second neural network model based on the overlapped area, or select at least one of the first object data, or the second object data, or combinations thereof as the input data.

9. The vehicle control apparatus of claim 1, wherein the processor is configured to:
identify data uncertainty for the input data based on the first sensor data and the second sensor data, which are entered into the first neural network model;
identify model uncertainty for the second neural network model based on a third neural network model different from the second neural network model; and
output the output data based on the input data, to which the data uncertainty is applied, and the second neural network model to which the model uncertainty is applied.

10. The vehicle control apparatus of claim 1, wherein the second neural network model includes a multi-layer perceptron neural network.

11. A vehicle control method, the method comprising:
obtaining first object data for predicting at least one of a first location of an external object, or a type of the external object, or combinations thereof based on entering first sensor data, which is obtained based on identifying the external object through a first sensor, into a first neural network model stored in a memory;
obtaining second object data for predicting at least one of a second location of the external object, or the type of the external object, or combinations thereof based on entering second sensor data, which is obtained based on identifying the external object through a second sensor, into a second neural network model stored in the memory;
selecting at least one of the first object data, or the second object data, or combinations thereof as input data to be entered into the second neural network model, based on at least one of a distance between the first location and the second location, first reliability of the first object data, or second reliability of the second object data, or combinations thereof; and
outputting output data including at least one of a final location of the external object, or a final type of the external object, or combinations thereof based on entering the input data into the second neural network model.

12. The method of claim 11, further comprising:
selecting at least one of the first object data, or the second object data, or combinations thereof as the input data based on whether the first reliability and the second reliability exceed reference reliability.

13. The method of claim 12, further comprising:
identifying the second reliability based on the first reliability exceeding the reference reliability;
selecting the first object data and the second object data as the input data based on whether the second reliability exceeds the reference reliability; and
selecting the first object data as the input data based on the second reliability being smaller than or equal to the reference reliability.

14. The method of claim 12, further comprising:
identifying the second reliability based on the first reliability being smaller than or equal to the reference reliability;
selecting the second object data as the input data, based on whether the second reliability exceeds the reference reliability;
removing the first object data and the second object data based on the second reliability being smaller than or equal to the reference reliability; and
selecting third object data, which is based on sensor data obtained by a third sensor different from the first sensor and the second sensor, as the input data.

15. The method of claim 11, further comprising:
identifying the first location, which is generated by the first object data and which indicates a center point of a first bounding box corresponding to the external object;
identifying the second location, which is generated by the second object data and which indicates a center point of a second bounding box corresponding to the external object; and
determining whether a distance between the first location and the second location exceeds a reference distance.

16. The method of claim 15, further comprising:
removing the first object data and the second object data based on the distance between the first location and the second location exceeding the reference distance; and
selecting third object data, which is based on sensor data obtained by a third sensor different from the first sensor and the second sensor, as the input data.

17. The method of claim 15, further comprising:
determining whether the first reliability and the second reliability exceed reference reliability, based on a fact that the distance between the first location and the second location is smaller than or equal to the reference distance.

18. The method of claim 11, further comprising:
identifying a first bounding box, which is generated by the first object data and which corresponds to the external object;
identifying a second bounding box, which is generated by the second object data and which corresponds to the external object;
identifying an area where the first bounding box overlaps the second bounding box; and
training the second neural network model based on the overlapped area, or selecting at least one of the first object data, or the second object data, or combinations thereof as the input data.

19. The method of claim 11, further comprising:
identifying data uncertainty for the input data based on the first sensor data and the second sensor data, which are entered into the first neural network model;
identifying model uncertainty for the second neural network model based on a third neural network model different from the second neural network model; and
outputting the output data based on the input data, to which the data uncertainty is applied, and the second neural network model to which the model uncertainty is applied.

20. The method of claim 11, wherein the second neural network model includes a multi-layer perceptron neural network.
